(19) United States
(12) Patent Application Publication
(10) Pub. No.: US 2012/0148836 A1
(43) Pub. Date: Jun. 14, 2012

(54) USE OF POLYELECTROLYTE COMPLEXES AS PLASTICIZER BARRIERS

(75) Inventors: Carmen-Elena Cimpeanu, Ludwigshafen (DE); Thomas Breiner, Laudenbach (DE); Dieter Urban, Speyer (DE); Karl-Heinz Schumacher, Nuestadt (DE); Axel Weiss, Speyer (DE); Axel Meyer, Heidelberg (DE); Soumyajit Roy, Calcutta (IN)

(73) Assignee: BASF SE, Ludwigshafen (DE)

(21) Appl. No.: 13/391,143

(22) PCT Filed: Aug. 12, 2010
(86) PCT No.: PCT/EP2010/061759

§ 371 Date: Feb. 17, 2012

(30) Foreign Application Priority Data
Aug. 20, 2009 (EP) 09168235.1

(51) Int. Cl. B32B 7/12; B05D 1/36; B32B 27/40; B32B 27/08; C09D 175/04; C09D 133/02

(52) U.S. Cl. 428/347; 524/500; 524/516; 428/424.6; 428/520; 428/354; 427/407.1

(57) ABSTRACT

The use of polyelectrolyte complexes as plasticizer barrier is described, in particular those formed from anionic polymer and from cationic polymer, as also are plasticized substrates and production of the same, where the plasticized substrates have been coated with at least one layer which comprises at least one polyelectrolyte complex.

The use of polyelectrolyte complexes as plasticizer barrier is described, in particular those formed from anionic polymer and from cationic polymer, as also are plasticized substrates and production of the same, where the plasticized substrates have been coated with at least one layer which comprises at least one polyelectrolyte complex.

Polymer foils, or other materials produced from organic polymers, often comprise what are known as plasticizers, in order to give these materials the desired flexibility. Plasticizers are particular inert liquid or solid organic substances with low vapor pressure, and within this group are predominantly materials which have the characteristics of esters and which can interact physically with highly polymeric substances and form a homogeneous system therewith, without undergoing any chemical reaction and preferably, but not always, by virtue of their solvating and swelling capability. Plasticizers provide certain desired physical properties to the structures or coatings produced therewith, examples being lower freezing point, increased capability for alteration of shape, an increased level of elastic properties, or reduced hardness. They are classed as plastics additives. They are introduced into materials, e.g. into flexible PVC, in order to improve their workability, flexibility, and extensibility. Examples of typical known plasticizers are phthalic esters, trimellitic esters with (predominantly) linear C₆-C₁₁ alcohols, or other dicarboxylic diesters.

One particular property which arises when plasticized plastics are used and which is often undesired is the ability of the plasticizers to migrate; this derives from processes relating to diffusion, vapor pressure, and convection, and is especially noticeable when the plastic is in contact with other liquid or solid substances. The plasticizer then penetrates into the other substance (these mostly being other plastics). This latter substance is solvated or corroded, or swelling phenomena arise, and indeed the material can even adhere to the surface of the substance with which it is in contact. Migration rate rises rapidly with temperature. In the case of adhesive applications, migration of plasticizers into the adhesive layer can lead to undesired reduction of adhesion, in particular at relatively high temperatures. Plasticizer migration is also a factor in physiological safety of food packaging.

The automobile industry uses PVC foils with plasticizer content up to 50% by weight (in particular of phthalic esters) for the industrial lamination of ABS substrates (acrylonitrile/butadiene/styrene copolymers). Examples of adhesives used for this purpose are polyester-based polyurethane dispersions, these being sprayed onto the substrate and dried, and activated thermally in a press for the actual adhesive-bonding process. It is desirable to use foils that have been previously coated with adhesive, since this considerably simplifies the laminating operation. However, when a foil of this type is stored the plasticizer can migrate out of the PVC foil into the adhesive layer, causing severe impairment of subsequent adhesive bonding. It is therefore desirable to inhibit plasticizer migration from a plasticizer-containing material to the surface of the same or into adjacent layers and materials. It was an object of the present invention to inhibit plasticizer migration from a plasticized material to the surface of the same or into adjacent layers and materials.

It has been found that polyelectrolyte complexes have high effectiveness as plasticizer barrier. The invention therefore provides the use of polyelectrolyte complexes as plasticizer barrier. The polyelectrolyte complexes have in particular been formed from at least one anionic polymer and from at least one cationic polymer.

The invention also provides a plasticized substrate, the surface of which has been at least to some extent coated with at least one layer which comprises at least one polyelectrolyte complex. The coating produced using the polyelectrolyte complex has plasticizer-barrier properties.

The term “plasticizer barrier” means that, in comparison with uncoated substrate, the resistance of a substrate surface to penetration by plasticizers has been increased.

The invention also provides a process for producing plasticized products with plasticizer barrier, where
(i) a substrate made of material comprising plasticizer is provided, and
(ii) the substrate is entirely or to some extent provided with one or more layers which comprise at least one polyelectrolyte complex.

In one embodiment of the process, the method of coating with the polyelectrolyte complex can use a composition comprising at least one previously produced polyelectrolyte complex. The composition comprising a previously produced polyelectrolyte complex is preferably an aqueous dispersion that can be produced by water-in-water emulsion polymerization.

In another embodiment of the process, the method of coating with the polyelectrolyte complex can delay formation of the polyelectrolyte complex until the material is on the substrate. In a possible procedure for this, the substrate is provided with a first coating and with a second coating that is in direct contact with the first coating, where one of the coatings comprises at least one anionic polymer and the other coating comprises at least one cationic polymer, and formation of the polyelectrolyte complex made of anionic polymer and of cationic polymer is delayed until the material is on the substrate. The two coating compositions can be applied simultaneously or in direct succession in one operation, where one of the coating compositions comprises the anionic polymer and the other coating composition comprises the cationic polymer.

Polyelectrolytes are ionic polymers. Polyelectrolyte complexes are the reaction products of oppositely charged ionic polymers. The polyelectrolyte complexes generally have a defined stoichiometric constitution, and this means that the equivalence ratio of anionic and cationic groups in these complexes is, or is in the vicinity of, 1. However, the polyelectrolyte complexes can also be predominantly anionically or predominantly cationically charged complexes. It is also possible in the invention that, alongside these polyelectrolyte complexes, a cationic or an anionic polymer is also present in excess, i.e. in free, not complexed, form.

Anionic polymers are polymers having anionic groups, in particular organic polymers having carboxylate, phosphate, sulfonate, or sulfate groups. It is also possible to use the corresponding acids, as long as they are either neutralized by bases comprised within the reaction medium or are converted into anionic groups by basic groups of the cationic polymer. Examples of suitable anionic polymers are those formed by free-radical polymerization of ethylenically unsaturated anionic monomers capable of free-radical polymerization. This group also comprises copolymers made of at least one anionic monomer and of one or more than one different non-ionic copolymerizable monomer(s).

Examples of ethylenically unsaturated anionic monomers that can be used are monoethylenically unsaturated C₃-C₁₀ or C₃-C₅ carboxylic acids, such as acrylic acid, methacrylic acid, ethacrylic acid, crotonic acid, maleic acid, fumaric acid, vinylsulfonic acid, styrenesulfonic acid, acrylamidomethylpropanesulfonic acid, vinylphosphonic acid, itaconic acid, and the alkali-metal salts, alkaline-earth-metal salts, or ammonium salts of these acids. Among the anionic monomers preferably used are acrylic acid, methacrylic acid, maleic acid, and 2-acrylamido-2-methylpropanesulfonic acid. Particular preference is given to aqueous dispersions of polymers based on acrylic acid. The anionic monomers can either be polymerized alone to give homopolymers or else can be polymerized in a mixture with one another to give copolymers. Examples of these are the homopolymers of acrylic acid, homopolymers of methacrylic acid, copolymers of acrylic acid and maleic acid, copolymers of acrylic acid and methacrylic acid, and copolymers of methacrylic acid and maleic acid.

However, the anionic monomers can also be polymerized in the presence of at least one other ethylenically unsaturated monomer. These monomers can be nonionic or else can bear a cationic charge. Examples of nonionic comonomers are acrylamide, methacrylamide, N—C₁-C₃-alkylacrylamides, N-vinylformamide, acrylic esters of monohydric alcohols having from 1 to 20 carbon atoms, e.g. in particular methyl acrylate, ethyl acrylate, isobutyl acrylate, and n-butyl acrylate, methacrylic esters of monohydric alcohols having from 1 to 20 carbon atoms, e.g. methyl methacrylate and ethyl methacrylate, and also vinyl acetate and vinyl propionate. Suitable cationic monomers which can be copolymerized with the anionc monomers are dialkylaminoethyl acrylates, dialkylaminoethyl methacrylates, dialkylaminopropyl acrylates, dialkylaminopropyl methacrylates, dialkylaminoethylacrylamides, dialkylaminoethylmethacrylamides, dialkylaminopropylacrylamides, dialkylaminopropylmethacrylamides, diallyldimethylammonium chloride, vinylimidazole, and also the respective basic monomers neutralized with acids and/or quaternized. Individual examples of cationic monomers are dimethylaminoethyl acrylate, dimethylaminoethyl methacrylate, diethylaminoethyl acrylate, diethylaminoethyl methacrylate, dimethyl-aminopropyl acrylate, dimethylaminopropyl methacrylate, diethylaminopropyl acrylate, and diethylaminopropyl methacrylate, dimethylaminoethylacrylamide, dimethylaminoethylmethacrylamide, dimethylaminopropylacrylamide, dimethylaminopropylmethacrylamide, diethylaminoethylacrylamide, and diethylaminopropylacrylamide. The basic monomers can have been completely or only to some extent neutralized and, respectively, quaternized, for example to an extent of from 1 to 99% in each case. Preferred quaternizing agent used for the basic monomers is dimethyl sulfate. However, the monomers can also be quaternized with diethyl sulfate or with alkyl halides, such as methyl chloride, ethyl chloride, or benzyl chloride. The amount used of the cationic monomers is at most such that the resultant amphoteric polymers have an excess of acid groups with respect to amine groups or, respectively, bear an excess of anionic charge. The excess of acid or, respectively, the excess of anionic charge in the resultant amphoteric polymers is, for example, at least 5 mol %, preferably at least 10 mol %. Examples of the amounts used of the comonomers in the production of the anionic polymers are amounts such that the resultant polymers are water-soluble when diluted with water at pH values above 7.0 and at a temperature of 20° C., and have an anionic charge. Examples of the amount of nonionic and/or cationic comonomers, based on the total amount of monomers used in the polymerization reaction, are from 0 to 99% by weight, preferably from 5 to 75% by weight, and mostly an amount in the range from 5 to 25% by weight.

Examples of preferred copolymers are copolymers made of from 25 to 99% by weight of acrylic acid and from 75 to 1% by weight of acrylamide. It is preferable to polymerize at least one ethylenically unsaturated C₃-C₅ carboxylic acid in the absence of other monoethylenically unsaturated monomers. Particular preference is given to homopolymers of acrylic acid, obtainable via free-radical polymerization of acrylic acid in the absence of other monomers.

In one embodiment, the anionic polymer comprises 2-acrylamido-2-methylpropane-sulfonic acid (AMPS). It is preferable to copolymerize acrylic acid with AMPS. The amount of AMPS here can be, for example, from 0.1 to 20 mol % or from 0.1 to 15 mol % or from 0.5 to 10 mol %, based on the amount of all of the monomers.

The polymerization reaction can also be conducted in the presence of at least one crosslinking agent. This then gives copolymers with higher molar mass than when the anionic monomers are polymerized in the absence of any crosslinking agent. Incorporation of a crosslinking agent into the polymers moreover gives reduced solubility of the polymers in water. As a function of the amount of copolymerized crosslinking agent, the polymers become insoluble in water, but are swellable in water. Crosslinking agents used can comprise any of the compounds that have at least two ethylenically unsaturated double bonds within the molecule. Examples of crosslinking agents are triallylamine, the triallyl ether of pentaerythritol, the tetraallyl ether of penta-erythritol, methylenebisacrylamide, N,N′-divinylethyleneurea, allyl ethers comprising at least two allyl groups, or vinyl ethers having at least two vinyl groups, where these ethers derive from polyhydric alcohols, e.g. sorbitol, 1,2-ethanediol, 1,4-butanediol, trimethylolpropane, glycerol, diethylene glycol, and from sugars, such as sucrose, glucose, mannose; other examples are dihydric alcohols which have from 2 to 4 carbon atoms and which have been completely esterified with acrylic acid or with methacrylic acid, e.g. ethylene glycol dimethacrylate, ethylene glycol diacrylate, butanediol dimethacrylate, butanediol diacrylate, diacrylates or dimethacrylates of polyethylene glycols with molecular weights from 300 to 600, ethoxylated trimethylenepropane triacrylates or ethoxylated trimethylenepropane trimethacrylates, 2,2-bis(hydroxymethyl)butanol trimethacrylate, pentaerythritol triacrylate, pentaerythritol tetraacrylate, and triallylmethylammonium chloride. If crosslinking agents are used in the production of the dispersions of the invention, examples of the respective amounts used of crosslinking agent are from 0.0005 to 5.0% by weight, preferably from 0.001 to 1.0% by weight, based on the entirety of monomers used in the polymerization reaction. Crosslinking agents preferably used are the triallyl ether of pentaerythritol, the tetrallyl ether of pentaerythritol, N,N′-divinylethyleneurea, allyl ethers of sugars such as sucrose, glucose or mannose, where these ethers comprise at least two allyl groups, and triallylamine, and also mixtures of these compounds.

If at least one anionic monomer is polymerized in the presence of at least one crosslinking agent, it is preferable to produce crosslinked copolymers of acrylic acid and/or methacrylic acid by polymerizing acrylic acid and/or methacrylic acid in the presence of the triallyl ether of pentaerythritol, the tetrallyl ether of pentaerythritol, N,N′-divinylethyleneurea, allyl ethers of sugars such as sucrose, glucose or mannose, where these ethers comprise at least two allyl groups, and triallylamine, and also mixtures of these compounds.

The cationic polymers used to form the polyelectrolyte complexes are preferably water-soluble, i.e. they have at least 1 g/l solubility in water at 20° C. Cationic polymers are polymers having cationic groups, in particular organic polymers having quaternary ammonium groups. It is also possible to use polymers having primary, secondary, or tertiary amine groups, as long as they are protonated either by acids comprised within the reaction medium or by acid groups of the anionic polymer, thus being converted to cationic groups. The amine groups or ammonium groups of the cationic polymer here can be present in the form of substituents or as a portion of the polymer chain. They can also be a portion of an aromatic or non-aromatic ring system.

Examples of suitable cationic polymers are those from the following group:
(a) polymers comprising vinylimidazolium units,
(b) polydiallyldimethylammonium halides,
(c) polymers comprising vinylamine units,
(d) polymers comprising ethyleneimine units,
(e) polymers comprising dialkylaminoalkyl acrylate units and/or comprising dialkylaminoalkyl methacrylate units, and
(f) polymers comprising dialkylaminoalkylacrylamide units and/or comprising dialkylaminoalkyl methacrylamide units.

Examples of cationic polymers are
(a) homopolymers of vinylimidazolium methosulfate and/or copolymers of vinylimidazolium methosulfate and N-vinylpyrrolidone,
(b) polydiallyldimethylammonium chlorides,
(c) polyvinylamines,
(d) polyethyleneimines,
(e) polydimethylaminoethyl acrylate, polydimethylaminoethyl methacrylate, copolymers of acrylamide and dimethylaminoethyl acrylate, and copolymers of acrylamide and dimethylaminoethyl methacrylate, where the basic monomers can also be present in the form of the salts with mineral acids, or in quaternized form, and
(f) polydimethylaminoethylacrylamide, polydimethylaminoethylmethacrylamide, and copolymers of acrylamide and dimethylaminoethylacrylamide.

The basic monomers can also be present in the form of the salts with mineral acids, or in quaternized form. The average molecular weights M_{w} of the cationic polymers are at least 500. By way of example, they are in the range from 500 to 1 million, preferably from 1000 to 500 000, or from 2000 to 100 000.

It is preferable to use the following as cationic polymers:
(a) homopolymers of vinylimidazolium methosulfate and/or copolymers of vinyl-imidazolium methosulfate and N-vinylpyrrolidone with average molecular weight M_{w} of from 500 to 500 000 in each case,
(b) polydiallyldimethylammonium chlorides with average molecular weight M_{w} of from 1000 to 500 000,
(c) polyvinylamines with average molecular weight M_{w}, of from 500 to 1 million, and
(d) polyethyleneimines with average molecular weight M_{w} of from 500 to 1 million.

The copolymers listed under (a) of vinylimidazolium methosulfate and N-vinylpyrrolidone comprise by way of example from 10 to 90% by weight of copolymerized N-vinylpyrrolidone. Instead of N-vinylpyrrolidone it is possible to use, as comonomer, at least one compound from the group of the ethylenically unsaturated C₃-C₅ carboxylic acids, particular examples being acrylic acid or methacrylic acid, or to use the esters of these carboxylic acids with monohydric alcohols comprising from 1 to 18 carbon atoms, e.g. methyl acrylate, ethyl acrylate, isopropyl acrylate, n-butyl acrylate, isobutyl acrylate, methyl methacrylate, ethyl methacrylate, or n-butyl methacrylate.

A polymer of group (b) that can be used with preference is polydiallyldimethylammonium chloride. Other suitable polymers are copolymers of diallyldimethylammonium chloride and dimethylaminoethyl acrylate, copolymers of diallyldimethylammonium chloride and dimethylaminoethyl methacrylate, copolymers of diallyldimethylammonium chloride and diethylaminoethyl acrylate, copolymers of diallyldimethylammonium chloride and dimethylaminopropyl acrylate, copolymers of diallyldimethylammonium chloride and dimethylaminoethylacrylamide, and copolymers of diallyldimethylammonium chloride and dimethylaminopropylacrylamide. The copolymers of diallyldimethylammonium chloride comprise, in copolymerized form by way of example from 1 to 50 mol %, mostly from 2 to 30 mol %, of at least one of the comonomers mentioned.

Polymers (c) comprising vinylamine units are obtainable via polymerization of N-vinylformamide, if appropriate in the presence of comonomers, and hydrolysis of the vinylformamide polymers with elimination of formyl groups to form amino groups. The degree of hydrolysis of the polymers can by way of example be from 1 to 100%, mostly being in the range from 60 to 100%. The average molecular weights M_{w} are up to 1 million. Polymers comprising vinylamine units are marketed by way of example as Catiofast® from BASF SE.

Polymers of group (d) comprising ethyleneimine units, for example polyethyleneimines, are likewise commercially available products. They are sold by way of example as Polymin® by BASF SE, an example being Polymin® SK. These cationic polymers are polymers of ethyleneimine which are produced via polymerization of ethyleneimine in an aqueous medium in the presence of small amounts of acids or of acid-forming compounds, examples being halogenated hydrocarbons, e.g. chloroform, carbon tetrachloride, tetrachloroethane, or ethyl chloride, or are condensates of epichlorohydrin and compounds comprising amino groups, examples being mono- and polyamines, e.g. dimethylamine, diethylamine, ethylenediamine, diethylenetetramine, and triethylenetetramine, or ammonia. By way of example, they have molecular weights M_{w} of from 500 to 1 million, preferably from 1000 to 500 000.

This group of cationic polymers also includes graft polymers of ethyleneimine on compounds having a primary or secondary amino group, examples being polyamidoamines made of dicarboxylic acids and of polyamines. The ethyleneimine-grafted polyamidoamines can also, if appropriate, be reacted with bifunctional crosslinking agents, for example with epichlorohydrin or with bischlorohydrin ethers of polyalkylene glycols.

Cationic polymers of group (e) that can be used in the polymerization reaction are polymers comprising dialkylaminoalkyl acrylate units and/or comprising dialkylaminoalkyl methacrylate units. These monomers can be used in the polymerization reaction in the form of the free bases, but are preferably used in the form of the salts with mineral acids, such as hydrochloric acid, sulfuric acid, or phosphoric acid, or else in quaternized form. Examples of quaternizing agents that can be used are dimethyl sulfate, diethyl sulfate, methyl chloride, ethyl chloride, cetyl chloride, or benzyl chloride. These monomers can be used to produce either homopolymers or copolymers. Examples of suitable comonomers are acrylamide, methacrylamide, N-vinylformamide, N-vinylpyrrolidone, methyl acrylate, ethyl acrylate, methyl methacrylate, and mixtures of the monomers mentioned.

Cationic polymers of group (f) are polymers comprising dimethylaminoethylacrylamide units or comprising dimethylaminoethylmethacrylamide units, which preferably comprise the basic monomers in the form of the salts with mineral acids, or in quaternized form. These materials can be homopolymers and copolymers. Examples are homopolymers of dimethylaminoethylacrylamide which has been completely quaternized with dimethyl sulfate or with benzyl chloride, homopolymers of dimethylaminoethylmethacrylamide which has been completely quaternized with dimethyl sulfate, with methyl chloride, with ethyl chloride, or with benzyl chloride, and copolymers of acrylamide and dimethyl-sulfate-quaternized dimethylaminoethylacrylamide.

The following cationic polymers are preferably used in production of the aqueous dispersions of the invention:
(a) homopolymers of vinylimidazolium methosulfate and/or copolymers of vinyl-imidazolium methosulfate and N-vinylpyrrolidone with average molecular weight M_{w} of from 1000 to 100 000 in each case,
(b) polydiallyldimethylammonium chlorides with average molecular weight M_{w} of from 2000 to 100 000, and/or
(c) polyvinylamines with average molecular weight M_{w} of from 1000 to 500 000. The polyvinylamines are preferably used in the form of the salts with sulfuric acid or hydrochloric acid.

Polymers that can be used as cationic polymers are not only these polymers composed solely of cationic monomers but also amphoteric polymers, with the proviso that the net charge that they bear is cationic. By way of example, the excess of cationic charge in the amphoteric polymers is at least 5 mol %, preferably at least 10 mol %, and mostly in the range from 15 to 95 mol %. Examples of amphoteric polymers having an excess of cationic charge are
copolymers of acrylamide, dimethylaminoethyl acrylate and acrylic acid, comprising at least 5 mol % more dimethylaminoethyl acrylate than acrylic acid as comonomer;
copolymers of vinylimidazolium methosulfate, N-vinylpyrrolidone, and acrylic acid, comprising at least 5 mol % more vinylimidazolium methosulfate than acrylic acid as comonomer;
hydrolyzed copolymers of N-vinylformamide and of an ethylenically unsaturated C₃-C₅ carboxylic acid, preferably acrylic acid or methacrylic acid, with at least 5 mol % higher content of vinylamine units than units of ethylenically unsaturated carboxylic acids; and
copolymers of vinylimidazole, acrylamide, and acrylic acid, where the pH has been selected in such a way that the amount of vinylimidazole cationically charged is at least 5 mol % more than the amount of copolymerized acrylic acid.

In one embodiment of the invention, aqueous dispersions of polyelectrolyte complexes are used. Cationic polymers and anionic polymers often tend to coagulate and precipitate in water. When aqueous dispersions of polyelectrolyte complexes are used according to the invention these are stable non-coagulated systems, by way of example capable of production by what is known as water-in-water emulsion polymerization. The polyelectrolyte complexes preferably have predominantly anionic charge. Stable aqueous dispersions of polyelectrolyte complexes can be produced by carrying out free-radical polymerization of the anionic monomers that can be used, if appropriate in the presence of other monomers, in an aqueous medium in the presence of cationic polymers. If the other, non-anionic monomers also comprise basic or, respectively, cationic monomers, the amount of these is selected in such a way that the resultant polymer complexes bear an excess of anionic charge (at pH 7 and 20° C.). The charge density of the polyelectrolytes or polyelectrolyte complexes can be determined by the method of D. Horn, Progr. Colloid & Polymer Sci., volume 65, 251-264 (1978). Basic polymers are preferably used in the polymerization reaction in the form of the salts with mineral acids or with organic acids, such as formic acid or acetic acid. These salts are in any case formed during the polymerization reaction, because it is conducted at pH<6.0.

In one embodiment of the invention, the amount used of the anionic monomers is such that the number of anionic groups of the anionic monomers exceeds, by at least 1 mol %, the number of cationic groups in the cationic polymers, measured at pH 7 and 20° C. By way of example, DE 10 2005 007 483 describes a suitable production process.

The amount of cationic polymer used for producing the polyelectrolyte complex is preferably judged in such a way that the amount of cationic groups used of at least one cationic polymer, measured at pH 7 and 20° C., per mole of the anionic groups of the anionic polymer or, respectively, in the entirety of the anionic monomers used in the polymerization reaction, is by way of example up to 150 mol % or up to 100 mol %, preferably from 1 to 99 mol % or from 2 to 50 mol %. The resultant polyelectrolyte complexes, which have less than 100 mol % of cationic groups, have predominantly anionic charge, at pH 7 and 20° C.

The aqueous dispersions which are preferred in the invention and which comprise predominantly anionically charged polyelectrolyte complexes can be produced via free-radical polymerization of ethylenically unsaturated anionic monomers in an aqueous medium in the presence of at least one water-soluble cationic polymer, where the amount used of at least one cationic polymer, per mole of the entirety of the anionic monomers used in the polymerization reaction, is preferably from 0.5 to 49 mol %. The polymerization reaction takes place in an aqueous medium at pH below 6, e.g. in the range from 0 to 5.9, preferably from 1 to 5, and in particular form 1.5 to 3. The pH value that can be used is mostly a consequence of the fact that polymers comprising acid groups are used in the free-acid-group form in the polymerization reaction. The pH can be varied by adding a base, such as in particular aqueous sodium hydroxide solution or potassium hydroxide solution for partial neutralization of the acid groups of the anionic monomers within the stated range. However, to the extent that the starting material comprises the alkali-metal salts, alkaline-earth-metal salts, or ammonium salts of the anionic monomers, a mineral acid is added, or an organic acid, such as formic acid, acetic acid, or propionic acid, in order to adjust pH.

The polymerization reaction can, if appropriate, also be carried out in the presence of at least one chain-transfer agent. The products are then polymers with lower molecular weight than polymers produced without chain-transfer agent. Examples of chain-transfer agents are organic compounds comprising bonded sulfur, e.g. dodecyl mercaptan, thiodiglycol, ethothioethanol, di-n-butyl sulfide, di-n-octyl sulfide, diphenyl sulfide, diisopropyl disulfide, 2-mercaptoethanol, 1,3-mercaptopropanol, 3-mercapto-propane-1,2-diol, 1,4-mercaptobutanol, thioglycolic acid, 3-mercaptopropionic acid, mercaptosuccinic acid, thioacetic acid, and thiourea, aldehydes, organic acids, such as formic acid, sodium formate, or ammonium formate, alcohols, such as in particular isopropanol, and also phosphorus compounds, e.g. sodium hypophosphite. It is possible to use a single chain transfer agent or a plurality of chain transfer agents in the polymerization reaction. If they are used in the polymerization reaction, an example of the amount used of these is from 0.01 to 5.0% by weight, preferably from 0.2 to 1% by weight, based on the entirety of the monomers. The chain transfer agents are preferably used together with at least one crosslinking agent in the polymerization reaction. The rheology of the resultant polymers can be controlled by varying the amount, and the ratio, of chain transfer agent and crosslinking agent. Chain transfer agent and/or crosslinking agent can by way of example be used as an initial charge in the aqueous polymerization medium for the polymerization reaction, or can be fed together with or separately from the monomers to the polymerization mixture, as a function of the progress of the polymerization reaction.

The polymerization reaction usually uses initiators which generate free radicals under the reaction conditions. Examples of suitable polymerization initiators are peroxides, hydroperoxides, hydrogen peroxide, sodium persulfate or potassium persulfate, redox catalysts and azo compounds, such as 2,2-azobis(N,N-dimethylenisobutyramidine) dihydrochloride, 2,2-azobis(4-methoxy-2,4-dimethylvaleronitrile), 2,2-azobis(2,4-dimethylvaleronitrile) and 2,2-azobis(2-amidinopropane) dihydrochloride. The amounts used of the initiators are those conventional in the polymerization reaction. It is preferable to use azo initiators as polymerization initiators. However, the polymerization reaction can also be initiated with the aid of energy radiation, such as electron beams, or irradiation with UV light.

The polymerization reaction to form the anionic polymers is by way of example carried out batchwise, by using anionic monomers and at least one cationic compound (e.g. the cationic polymer) as initial charge in a polymerization zone, with portioned or continuous feed of the polymerization initiator. However, preference is given to a semicontinuous procedure in which water and polymerization initiator are used as initial charge and at least one anionic monomer and at least one cationic polymer are fed continuously under polymerization conditions. However, it is also possible to introduce the initiator continuously or portioned into the polymerization zone, but separately from monomer feed and from cationic-polymer feed. Another possible procedure begins by using a portion of the monomers, e.g. from 5 to 10% by weight, together with a corresponding proportion of at least one cationic polymer as initial charge in a polymerization zone, initiating the polymerization reaction in the presence of an initiator, and adding the remaining portion of the monomers, of the cationic polymer, and of the initiator in continuous or portioned form. The polymerization reaction usually always takes place with exclusion of oxygen under an inert-gas atmosphere, for example under nitrogen or helium. The polymerization temperatures are by way of example in the range from 5 to 100° C., preferably from 15 to 90° C., and mostly from 20 to 70° C. The polymerization temperature is very dependent on the respective initiator used.

The concentration of the polyelectrolyte complexes in the solutions or aqueous dispersions used for the coating process is preferably at least 1% by weight, in particular at least 5% by weight, and up to 50 or up to 60% by weight. It is preferable that the content of polyelectrolyte complexes in the aqueous dispersion is from 1 to 40% by weight or from 5 to 35% by weight, in particular from 15 to 30% by weight.

The viscosity of preferred aqueous dispersions of the polyelectrolyte complexes at pH below 6.0 and at a temperature of 20° C. is from 100 to 150 000 mPas, or from 200 to 5000 mPas (measured using a Brookfield viscometer at 20° C., 20 rpm, spindle 4). The polyelectrolyte complexes have different molecular weights as a function of the polymerization conditions and of the respective monomers used or combinations of monomers used and auxiliaries used, such as chain transfer agents. The average molecular weight M_{w} of the polyelectrolyte complexes is by way of example from 1000 to 10 million, preferably from 5000 to 5 million, or from 10 000 to 3 million. The molecular weight is determined with the aid of light scattering. The average particle size of the dispersed polyelectrolyte complexes is by way of example from 0.1 to 200 μm, preferably from 0.5 to 70 μm. It can be determined by way of example with the aid of an optical microscope, or of light scattering, or of freeze-fracture electron microscopy.

Particular embodiments of the invention are the use of polyelectrolyte complexes formed from
homopolymers of acrylic acid and polymers comprising vinylimidazolium units;
homopolymers of acrylic acid and homopolymers having vinylimidazolium units;
homopolymers of acrylic acid and copolymers of monomers having vinylimidazolium units and of vinyllactams, in particular vinylpyrrolidone;
copolymers of acrylic acid with 2-acrylamido-2-methylpropanesulfonic acid and polymers comprising vinylimidazolium units;
copolymers of acrylic acid with 2-acrylamido-2-methylpropanesulfonic acid and homopolymers having vinylimidazolium units;
copolymers of acrylic acid with 2-acrylamido-2-methylpropanesulfonic acid and copolymers of monomers having vinylimidazolium units and of vinyllactams, in particular vinylpyrrolidone.

In one embodiment of the invention, a combination of a cationic polyurethane and an anionic polyurethane is used to form the polyelectrolyte complex. An anionic polyurethane comprises either anionic groups and no cationic groups or both anionic and cationic groups, the number of anionic groups being greater. A cationic polyurethane comprises either cationic groups and no anionic groups or both anionic and cationic groups, the number of cationic groups being greater. The cationic and anionic polyurethanes are preferably used separately from one another and in the form of aqueous dispersions, whereupon the polyelectrolyte complex forms when the at least two different aqueous dispersions are applied to the substrate.

The cationic polyurethanes are preferably composed of a) polyisocyanates, preferably at least one diisocyanate, b) polyols, preferably at least one polyesterdiol or at least one polyetherdiol, and c) optionally further mono- or polyfunctional compounds having reactive groups by way of example selected from alcoholic hydroxy groups, primary amino groups, secondary amino groups, and isocyanate groups, where at least one of the structural components has one or more cationic groups.

The anionic polyurethanes are preferably composed of a) polyisocyanates, preferably at least one diisocyanate, b) polyols, preferably at least one polyesterdiol or at least one polyetherdiol, and c) optionally further mono- or polyfunctional compounds having reactive groups by way of example selected from alcoholic hydroxy groups, primary amino groups, secondary amino groups, and isocyanate groups, where at least one of the structural components has one or more anionic groups.

Examples of suitable diisocyanates are those of the formula X(NCO)₂, where X is an aliphatic hydrocarbon radical having from 4 to 15 carbon atoms, a cycloaliphatic or aromatic hydrocarbon radical having from 6 to 15 carbon atoms, or an araliphatic hydrocarbon radical having from 7 to 15 carbon atoms. Examples of these diisocyanates are tetramethylene diisocyanate, hexamethylene diisocyanate, dodeca-methylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), e.g. the trans/trans isomer, the cis/cis isomer, and the cis/trans isomer, and also mixtures composed of these compounds. These diisocyanates are available commercially. Particularly important mixtures of these isocyanates are the mixtures of the respective structural isomers of diisocyanatotoluene and diisocyanatodiphenylmethane, and the mixture made of 80 mol % of 2,4-diisocyanatotoluene and 20 mol % of 2,6-diisocyanatotoluene is particularly suitable. The mixtures of aromatic isocyanates, such as 2,4-diisocyanatotoluene and/or 2,6-diisocyanatotoluene, with aliphatic or cycloaliphatic isocyanates, such as hexamethylene diisocyanate or IPDI are also particularly advantageous, the preferred mixing ratio of the aliphatic to aromatic isocyanates being from 1:9 to 9:1, in particular from 1:4 to 4:1.

The structure of the polyurethanes can also use, as polyisocyanate compounds other than the abovementioned compounds, isocyanates which bear not only the free isocyanate groups but also other capped isocyanate groups, e.g. uretdione groups.

It is preferable that each of the polyurethanes is composed of at least 40% by weight, particularly preferably at least 60% by weight, and very particularly preferably at least 80% by weight, of diisocyanates, polyetherdiols, and/or polyesterdiols. It is preferable that the polyurethanes comprise an amount of more than 10% by weight, particularly preferably greater than 30% by weight, in particular greater than 40% by weight or greater than 50% by weight, and very particularly preferably greater than 60% by weight, based on the polyurethane, of polyesterdiols or polyetherdiols, or a mixture thereof.

Polyesterdiols that can be used are mainly relatively high-molecular-weight diols with molar mass from above 500 up to 5000 g/mol, preferably about 1000 to 3000 g/mol. The molar mass of polyetherdiols is preferably from 240 to 5000 g/mol. This is the number-average molar mass Mn. Mn is obtained from determination of the number of end groups (OH number).

Polyesterdiols are known by way of example from Ullmanns Enzyklopädie der technischen Chemie [Ullmann's Encyclopedia of Industrial Chemistry], 4^{th} edition, volume 19, pp. 62 to 65. It is preferable to use polyesterdiols which are obtained via reaction of dihydric alcohols with dihydric carboxylic acids. Instead of the free carboxylic acids, it is also possible to use the corresponding polycarboxylic anhydrides or corresponding polycarboxylic esters of lower alcohols, or a mixture of these, to produce the polyester polyols. The polycarboxylic acids can be aliphatic, cycloaliphatic, araliphatic, aromatic, or heterocyclic, and, if appropriate, can have unsaturation and/or substitution, for example by halogen atoms. Examples that may be mentioned of these are: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, dimeric fatty acids. Preference is given to dicarboxylic acids of the general formula HOOC—(CH₂)_{y}—COOH, where y is a number from 1 to 20, preferably an even number from 2 to 20, examples being succinic acid, adipic acid, sebacic acid, and dodecanedicarboxylic acid.

Examples of dihydric alcohols that can be used for producing the polyesterdiols are ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes, such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples of these materials are ethylene glycol, butane-1,4-diol, hexane-1,6-diol, octane-1,8-diol, and dodecane-1,12-diol. Preference is further given to neopentyl glycol.

In addition to the polyesterdiols or the polyetherdiols, it is also possible, if appropriate, to make concomitant use of the polycarbonatediols that can by way of example be obtained via reaction of phosgene with an excess of the low-molecular-weight alcohols mentioned as structural components for the polyester polyols. It is also possible, if appropriate, to use lactone-based polyesterdiols, these being homo- or copolymers of lactones, preferably products derived from addition reactions of lactones onto suitable difunctional starter molecules and having terminal hydroxy groups. Lactones that can be used are preferably those deriving from compounds of the general formula HO—(CH₂)_{z}—COOH, where z is a number from 1 to 20, and a hydrogen atom of a methylene unit can also have been substituted by a C₁-C₄-alkyl radical. Examples are ε-caprolactone, β-propiolactone, γ-butyrolactone, and/or methyl-ε-caprolactone, and also mixtures of these. Examples of suitable starter components are the low-molecular-weight dihydric alcohols mentioned above as structural components for the polyester polyols. Particular preference is given to the corresponding polymers of ε-caprolactone. Lower polyesterdiols or polyetherdiols can also have been used as starters for producing the lactone polymers. Instead of the polymers of lactones, it is also possible to use the corresponding chemically equivalent polycondensates of the hydroxycarboxylic acids that correspond to the lactones.

Polyetherdiols can be obtained in particular via homopolymerization of ethylene oxide, propylene oxide, butylene oxide, tetrahydrofuran, styrene oxide, or epichlorohydrin, e.g. in the presence of BF₃, or via an addition reaction of these compounds, if appropriate in a mixture or in succession, onto starter components having reactive hydrogen atoms, examples being alcohols or amines, e.g. water, ethylene glycol, propane-1,2-diol, propane-1,3-diol, 2,2-bis(4-hydroxyphenyl)propane, or aniline. Particular preference is given to propylene oxide, and to polytetrahydrofuran of molecular weight from 240 to 5000, and especially from 500 to 4500. Preference is given to polyetherdiols composed of less than 20% by weight of ethylene oxide.

It is also possible, if appropriate, to make concomitant use of polyhydroxyolefins, preferably those having 2 terminal hydroxyl groups, e.g. α,ω-dihydroxypolybutadiene, α,ω-dihydroxypolymethacrylic ester, or α,ω-dihydroxypolyacrylic ester, as monomers (c1). These compounds are known by way of example from EP-A 622 378. Other suitable polyols are polyacetals, polysiloxanes, and alkyd resins.

The polyetherdiols have preferably been selected from polytetrahydrofuran and polypropylene oxide. The polyesterdiols have preferably been selected from reaction products of dihydric alcohols with dibasic carboxylic acids and lactone-based polyesterdiols.

The hardness and modulus of elasticity of the polyurethanes can, if necessary, be increased if the diols used comprise not only the polyesterdiols and, respectively, the polyetherdiols but also low-molecular-weight monomeric diols which differ therefrom with molar mass of about 60 to 500 g/mol, preferably 62 to 200 g/mol. Low-molecular-weight monomeric diols used are especially the structural components of the short-chain alkanediols mentioned for the production of polyester polyols, preference being given here to the unbranched diols having from 2 to 12 carbon atoms and having an even number of carbon atoms, and also to pentane-1,5-diol and neopentyl glycol. Examples are ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes, such as 1,4-bis(hydroxymethyl)cyclohexane, 2-methylpropane-1,3-diol, and methylpentanediols, and other compounds that can be used are diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples here are ethylene glycol, butane-1,4-diol, hexane-1,6-diol, octane-1,8-diol, and dodecane-1,12-diol. Preference is further given to neopentyl glycol. The proportion of the polyesterdiols and, respectively, of the polyetherdiols, based on the total amount of all of the diols, is preferably from 10 to 100 mol %, and the proportion of the low-molecular-weight, monomeric diols, based on the total amount of all of the diols, is preferably form 0 to 90 mol %. It is particularly preferable that the ratio of the polymeric diols to the monomeric diols is from 0.1:1 to 5:1, particularly from 0.2:1 to 2:1.

In order to achieve water-dispersibility of the polyurethanes, the polyurethanes can also comprise, as structural component, monomers which bear at least one isocyanate group or which bear at least one group reactive toward isocyanate groups and which moreover bear at least one hydrophilic group or one group which can be converted into a hydrophilic group. In the text below, the expression “hydrophilic groups or potentially hydrophilic groups” is abbreviated to “(potentially) hydrophilic groups”. The (potentially) hydrophilic groups react with isocyanates substantially more slowly than the functional groups of the monomers which serve for the structure of the main polymer chain. The proportion of components having (potentially) hydrophilic groups, based on the total amount of all of the structural components of the polyurethanes, is generally judged in such a way that the molar amount of the (potentially) hydrophilic groups, based on the total weight of all of the monomers, is from 30 to 1000 mmol/kg, preferably from 50 to 500 mmol/kg, and particularly preferably from 80 to 300 mmol/kg. The (potentially) hydrophilic groups can be nonionic or preferably (potentially) ionic hydrophilic groups. Particular nonionic hydrophilic groups that can be used are polyethylene glycol ethers preferably made of from 5 to 100, with preference from 10 to 80, repeat units of ethylene oxide. The content of polyethylene oxide units is generally form 0 to 10% by weight, preferably from 0 to 6% by weight, based on the total amount of all of the monomers. Preferred monomers having nonionic hydrophilic groups are polyethylene oxide diols having at least 20% by weight of ethylene oxide, polyethylene oxide monools, and also the reaction products of a polyethylene glycol and of a diisocyanate, where these bear a terminally etherified polyethylene glycol radical. Patent specifications U.S. Pat. No. 3,905,929 and U.S. Pat. No. 3,920,598 cite diisocyanates of this type and processes for producing the same.

The anionic polyurethanes comprise monomers having anionic groups, as structural components. Anionic groups are especially the sulfonate group, the carboxylate group, and the phosphate group, in the form of their alkali-metal salts or of their ammonium salts. The cationic polyurethanes comprise monomers having cationic groups, as structural components. Cationic groups are especially ammonium groups, in particular protonated tertiary amino groups, or quaternary ammonium groups. Other anionic and, respectively, cationic groups for the purposes of the invention are potentially anionic and, respectively, potentially cationic groups which can be converted via simple neutralization reactions, hydrolysis reactions, or quaternization reactions, into the abovementioned ionic hydrophilic groups, examples therefore being carboxylic acid groups or tertiary amino groups. (Potentially) ionic monomers are described in detail by way of example in Ullmanns Enzyklopädie der technischen Chemie [Ullmann's Encyclopedia of Industrial Chemistry], 4^{th} edition, volume 19, S.311-313, and by way of example in DE-A 1 495 745.

Particular practical importance as (potentially) cationic monomers is especially attached to monomers having tertiary amino groups, examples being: tris(hydroxyalkyl)amines, N,N-bis(hydroxyalkyl)alkylamines, N-hydroxyalkyldialkylamines, tris(aminoalkyl)amines, N,N-bis(aminoalkyl)alkylamines, and N-aminoalkyldialkylamines, where the alkyl radicals and alkanediyl units of these tertiary amines are composed independently of one another of from 1 to 6 carbon atoms. Other compounds that can be used are polyethers having tertiary nitrogen atoms and preferably having two terminal hydroxy groups, for example those obtainable in a conventional manner via alkoxylation of amines having two hydrogen atoms bonded to amine nitrogen, examples being methylamine, aniline, or N,N′-dimethylhydrazine. The molar mass of these polyethers is generally from 500 to 6000 g/mol. These tertiary amines are converted into the ammonium salts either by acids, preferably strong mineral acids, such as phosphoric acid, sulfuric acid, or hydrohalic acids, or by strong organic acids, or via reaction with suitable quaternizing agents, such as C₁-C₆-alkyl halides or benzyl halides, e.g. bromides or chlorides.

Particularly preferred structural components for cationic polyurethanes are N,N-bis(aminoalkyl)alkylamines, in particular N,N-bis(aminopropyl)methylamine, and also N,N-bis(hydroxyalkyl)alkylamines, particularly N,N-bis(2-hydroxyethyl)methylamine.

Monomers that can be used having (potentially) anionic groups are usually aliphatic, cycloaliphatic, araliphatic, or aromatic carboxylic acids and sulfonic acids which bear at least one alcoholic hydroxy group or which bear at least one primary or secondary amino group. Preference is given to the dihydroxyalkylcarboxylic acids, especially those having from 3 to 10 carbon atoms, also described in U.S. Pat. No. 3,412,054.

Compounds of the general formula (c1)

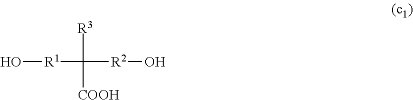

in which R¹ and R² are a C₁-C₄-alkanediyl unit and R³ is a C₁-C₄-alkyl unit are particularly preferred, especially dimethylolpropionic acid (DMPA). Other suitable compounds are corresponding dihydroxysulfonic acids and dihydroxyphosphonic acids, such as 2,3-dihydroxypropanephosphonic acid. Other suitable compounds are dihydroxy compounds with molar mass from above 500 to 10 000 g/mol having at least two carboxylate groups and disclosed in DE-A 39 11 827. They are obtainable via reaction of dihydroxy compounds with tetracarboxylic dianhydrides, such as pyromellitic dianhydride or cyclopentanetetracarboxylic dianhydride, in a molar ratio of from 2:1 to 1.05:1, in a polyaddition reaction. Particularly suitable dihydroxy compounds are the monomers listed above as chain extenders, and also the abovementioned diols.

Particularly preferred anionic structural components have carboxy groups. The carboxy groups can be introduced into the polyurethanes by way of the abovementioned aliphatic, cycloaliphatic, araliphatic, or aromatic carboxylic acids which bear at least one alcoholic hydroxy group or which bear at least one primary or secondary amino group. Preference is given to dihydroxyalkylcarboxylic acids, especially having from 3 to 10 carbon atoms, particularly dimethylolpropionic acid.

One particularly preferred structural component for anionic polyurethanes is 2,2-bis(hydroxymethyl)propionic acid (dimethylolpropionic acid, DMPA).

Other anionic structural components that can be used, having amino groups reactive toward isocyanates, are aminocarboxylic acids, such as lysine or β-alanine, or the adducts mentioned in DE-A 20 34 479 of aliphatic diprimary diamines with α,β unsaturated carboxylic or sulfonic acids. These compounds comply by way of example with the formula (c2)

H₂N—R₄—NH—R₅—X (c2)

in which R⁴ and R⁵, independently of one another, are a C₁-C₆-alkanediyl unit, preferably ethylene, and X is COOH or SO₃H. Particularly preferred compounds of the formula (c2) are N-(2-aminoethyl)-2-aminoethanecarboxylic acid, and also N-(2-amino-ethyl)-2-aminoethanesulfonic acid and the corresponding alkali-metal salts, particular preference being given here to Na as counterion. Particular preference is further given to the adducts of the abovementioned aliphatic diprimary amines with 2-acrylamido-2-methylpropanesulfonic acid, for example those described in DE-B 1 954 090.

If monomers having potentially ionic groups are used, they can be converted to the ionic form prior to or during, but preferably after, the isocyanate-polyaddition reaction, since the ionic monomers are often only sparingly soluble in the reaction mixture. Examples of neutralizing agents are ammonia, NaOH, triethanolamine (TEA), triisopropylamine (TIPA) or morpholine, or derivatives thereof. It is particularly preferable that the sulfonate or carboxylate groups are put into the form of their salts with an alkali-metal ion or with an ammonium ion as counterion.

Further, polyfunctional monomers can be used for the crosslinking or chain-extension of the polyurethanes. These are generally more than dihydric non-phenolic alcohols, amines having 2 or more primary and/or secondary amino groups, or else compounds which bear not only one or more alcoholic hydroxy groups but also one or more primary and/or secondary amino groups. Examples of alcohols having functionality higher than 2 which can be used to adjust to a particular degree of branching or crosslinking are trimethylolpropane, glycerol, or sugars. It is also possible to use polyamines having 2 or more primary and/or secondary amino groups, and monoalcohols, where these bear, in addition to the hydroxy group, a further group reactive toward isocyanates, examples being monoalcohols having one or more primary and/or secondary amino groups, e.g. monoethanolamine. The polyurethanes preferably comprise from 1 to 30 mol %, particularly preferably from 4 to 25 mol %, based on the total amount of all of the structural components, of a polyamine having at least two amino groups reactive toward isocyanates. It is also possible to use isocyanates of functionality greater than 2 for the same purpose. Examples of commercially available compounds are the isocyanurate or the biuret of hexamethylene diisocyanate.

Monofunctional monomers which are used concomitantly, if appropriate, are monoisocyanates, monoalcohols, and monoprimary and -secondary amines. Their proportion is generally at most 10 mol %, based on the total molar amount of the monomers. These monofunctional compounds usually bear further functional groups, e.g. olefinic groups or carbonyl groups, and are used to introduce, into the polyurethane, functional groups which permit dispersion or, respectively, crosslinking or further polymer-analogous reaction of the polyurethane. Monomers that can be used for this are isopropenyl-α,α-dimethylbenzyl isocyanate (TMI) and esters of acrylic or methacrylic acid, e.g. hydroxyethyl acrylate or hydroxyethyl methacrylate.

The method for adjusting the molecular weight of the polyurethanes via selection of the proportions of the monomers that can react with one another, and selection of the arithmetic average of the number of reactive functional groups per molecule, is well known in the field of polyurethane chemistry. The components and their respective molar amounts are normally selected in such a way that the ratio A:B, where
A is the molar amount of isocyanate groups, and
B is the total of the molar amount of the hydroxy groups and the molar amount of the functional groups that can react with isocyanates in an addition reaction,
   is from 0.5:1 to 2:1, preferably from 0.8:1 to 1.5:1, particularly preferably from 0.9:1 to 1.2:1. It is very particularly preferable that the ratio A:B is as close as possible to 1:1. The monomers usually bear an average of from 1.5 to 2.5, preferably from 1.9 to 2.1, particularly preferably 2.0, isocyanate groups and, respectively, functional groups which can react with isocyanates in an addition reaction.

The polyaddition reaction of the structural components to produce the polyurethane preferably takes place at reaction temperatures of up to 180° C., preferably up to 150° C., at atmospheric pressure or under autogenous pressure. The production of polyurethanes and of aqueous polyurethane dispersions is known to the person skilled in the art.

The polyurethanes preferably take the form of aqueous dispersion, being used in this form.

The anionic polyurethane is preferably composed of
a) diisocyanates,
b) polyesterdiols with molar mass of greater than 500 to 5000 g/mol, and/or polyetherdiols with molar mass of from 240 to 5000 g/mol,
c) diols having carboxylic acid groups, and
d) optionally further mono- or polyfunctional compounds which differ from a)-c) and have reactive groups, selected from alcoholic hydroxy groups, primary amino groups, secondary amino groups, and isocyanate groups.

The cationic polyurethane is preferably composed of
a) diisocyanates,
b) polyesterdiols with molar mass of greater than 500 to 5000 g/mol, and/or polyetherdiols with molar mass of from 240 to 5000 g/mol,
c) compounds which have at least one tertiary amine group, and 1, 2, or 3 functional groups selected from hydroxy groups, primary amine groups, and secondary amine groups, and
d) optionally further mono- or polyfunctional compounds which differ from a)-c) and have reactive groups, selected from alcoholic hydroxy groups, primary amino groups, secondary amino groups, and isocyanate groups.

For use as plasticizer barrier, the polyelectrolyte complexes composed of at least one anionic polymer and of at least one cationic polymer are applied to the surface of a substrate comprising at least one plasticizer, or are formed on the surface.

Plasticizers are particular inert liquid or solid organic substances with low vapor pressure, and within this group are predominantly materials which have the characteristics of esters and which can interact physically with highly polymeric substances and form a homogeneous system therewith, without undergoing any chemical reaction and preferably by virtue of their solvating and swelling capability. Plasticizers provide certain desired physical properties to the structures or coatings produced therewith, examples being lower freezing point, increased capability for alteration of shape, an increased level of elastic properties, or reduced hardness. They are classed as plastics additives. They are introduced into materials, e.g. into flexible PVC, in order to improve their workability, flexibility, and extensibility. Examples of preferred plasticizers are phthalic esters; (e.g. dioctyl phthalate, diisononyl phthalate, diisodecyl phthalate; dibutyl phthalate, diisobutyl phthalate, dicyclohexyl phthalate; dimethyl phthalate, diethyl phthalate, mixed esters made of benzyl butyl, butyl octyl, butyl decyl, and dipentyl phthalate, bis(2-methoxyethyl)phthalate, dicapryl phthalate, and the like); trimellitic esters with (predominantly) linear C₆-C₁₁ alcohols (e.g. tris(2-ethylhexyl)trimellitate); acyclic, aliphatic dicarboxylic esters (e.g. dioctyl adipate, diisodecyl adipate, dibutyl sebacate, dioctyl sebacate, decanedioic esters, or azelates); alicyclic dicarboxylic esters (e.g. diisononylcyclohexanedicarboxylic esters), phosphoric esters (e.g. tricresyl phosphate, triphenyl phosphate, diphenyl cresyl phosphate, diphenyl octyl phosphate, tris(2-ethylhexyl)phosphate, tris(2-butoxyethyl)phosphate; citric esters, lactic esters, epoxy plasticizers, benzenesulfonamides, methylbenzenesulfonamides, and the like. Particularly preferred plasticizers are diisononyl cyclohexanedicarboxylate, dibutyl phthalate, diisononyl phthalate, and dinonyl undecyl phthalate.

The plasticized substrates are preferably materials made of polyvinyl chloride (PVC, flexible PVC), i.e. a substrate made of flexible PVC comprising plasticizer is provided with a barrier layer comprising at least one polyelectrolyte complex. The surface of the substrate here is at least to some extent coated with at least one layer which comprises at least one polyelectrolyte complex. In one preferred embodiment, the substrate is a plasticized PVC foil. The PVC foil has been coated on one or both sides, preferably on one side, with the polyelectrolyte complex of the invention.

In one preferred embodiment of the invention, a constituent of the polyelectrolyte complex is an anionic polymer selected from anionic polyurethanes and from polymers capable of production from monomers selected from the group consisting of monoethylenically unsaturated C₃-C₁₀ carboxylic acids, vinylsulfonic acid, styrenesulfonic acid, acrylamidomethylpropanesulfonic acid, vinylphosphonic acid, and salts of these acids.

In one preferred embodiment of the invention, a constituent of the polyelectrolyte complex is a cationic polymer selected from the group consisting of cationic polyurethanes, polymers comprising vinylimidazolium units, polydiallyldimethylammonium halides, polymers comprising vinylamine units, polymers comprising ethyleneimine units, polymers comprising dialkylaminoalkyl acrylate units, polymers comprising dialkylaminoalkyl methacrylate units, polymers comprising dialkylaminoalkylacrylamide units, and polymers comprising dialkylaminoalkylmethacrylamide units.

In one preferred embodiment of the invention, the polyelectrolyte complex is formed from an anionic polyurethane and from a cationic polyurethane, or from a polymer polymerized by a free-radical route using acrylic acid or using methacrylic acid, and from a polymer having amino groups or having quaternary ammonium groups.

In one embodiment of the invention, the layer comprising the at least one polyelectrolyte complex has also been entirely or at least to some extent, directly or indirectly, coated with an adhesive layer. The adhesive has preferably been selected from heat-sealable adhesives, cold-sealable adhesives, pressure-sensitive adhesives, hot-melt adhesives, radiation-crosslinkable adhesives, and thermally crosslinkable adhesives. By way of example, the invention provides a heat-sealable flexible-PVC foil which has an outer, heat-sealable layer, where there is, located between the backing material made of flexible PVC and the heat-sealable layer, a barrier layer comprising at least one polyelectrolyte complex. By way of example, the invention also provides a self-adhesive flexible-PVC tape where there is, located between backing material made of flexible PVC and outer pressure-sensitive-adhesive layer, a barrier layer comprising at least one polyelectrolyte complex.

It is preferable that the process of the invention coats plasticized substrates with an aqueous solution or aqueous dispersion of at least one polyelectrolyte complex. Particularly suitable substrates are plasticized plastics moldings or plasticized polymer foils, in particular PVC foils. The solutions or dispersions used for the coating process can comprise further additives or auxiliaries, examples being thickeners for adjusting rheology, wetting aids, or binders.

In an example of a use, coating machines are employed, the method being that the coating composition is applied to a backing foil made of a plastic. If materials in the form of webs are used, the polymer dispersion is usually applied from a trough by way of an applicator roll and rendered uniform with the aid of an air knife. Other successful ways of applying the coating use, for example, the reverse gravure process, spray processes, or a spreader system that uses a roller.

Suitable processes for producing a barrier coating by means of a polyelectrolyte complex, other than these coating processes, are the intaglio printing, and letterpress printing processes known in printing technology. Instead of using different inks in the printing-ink units, the process here by way of example uses a printing process for alternate application of the different polymers. Printing processes that may be mentioned are the flexographic printing process as a relief printing process known to the person skilled in the art, the gravure process as an example of intaglio printing, and offset printing as an example of flatbed printing. Modern digital printing, inkjet printing, electrophotography, or direct imaging can also be used.

In one embodiment, formation of the polyelectrolyte complex is delayed until the material is in situ on the substrate, by applying two coating compositions simultaneously or in direct succession in one operation, e.g. via a cascade coating process, where one of the coating compositions comprises at least one anionic polymer and the other coating composition comprises at least one cationic polymer. It is preferable here to begin by applying at least one first coating composition which comprises at least one cationic polymer having primary, secondary, or tertiary amine groups, or which comprises at least one cationic polyurethane, and then to apply at least one second coating composition which comprises at least one anionic polymer having acid groups or which comprises at least one anionic polyurethane. Examples of the cationic polymers having amino groups are polymers having units selected from the group consisting of vinylamine, ethyleneimine, dialkylaminoalkyl acrylate, dialkylaminoalkyl methacrylate, dialkylaminoalkylacrylamide, dialkylaminoalkylmethacrylamide, and mixtures of these; in particular polyvinylamines, polyethyleneimines, polydimethylaminoethyl acrylate, polydimethylaminoethyl methacrylate, copolymers of acrylamide and dimethylaminoethyl acrylate, and copolymers of acrylamide and dimethylaminoethyl methacrylate. Examples of the anionic polymers having acid groups are polymers having units selected from acrylic acid, methacrylic acid, maleic acid, 2-acrylamido-2-methylpropanesulfonic acid, and mixtures thereof, in particular homopolymers of acrylic acid and copolymers of acrylic acid and of 2-acrylamido-2-methylpropanesulfonic acid.

In order to achieve a further improvement in adhesion on a foil, the backing foil can have been previously subjected to corona treatment. The amounts applied to the sheet materials are by way of example from 1 to 10 g (polymer, solids) per m², preferably from 2 to 7 g/m² in the case of foils. After application of the polyelectrolyte complexes to the sheet substrates, the solvent is evaporated. For this, by way of example, in the case of a continuous operation, the material can be passed through a drying tunnel, which can have an infrared irradiation apparatus. The coated and dried material is then passed over a cooling roll, and finally wound up. The thickness of the dried coating is preferably from 1 to 50 μm, particularly preferably from 2 to 20 μm.

The substrates coated with the polyelectrolyte complex exhibit excellent barrier action in inhibiting the migration of plasticizers, and in particular even in buckled, creased, and angled regions. The coated substrates can be used as they stand, for example as graphic design elements (graphic art), for the lamination of furniture or of moldings in automobile construction, e.g. interior door cladding, or as a means of packaging, or as adhesive tapes. The coatings have very good mechanical properties and exhibit by way of example good behavior in relation to blocking, and in essence no cracking. In order to attain specific surface properties or specific coating properties, for example good printability, a further improvement in behavior with respect to sealing and blocking, or good water-resistance, it can be advantageous to use topcoat layers which provide these additional desired properties, for overcoating of the polyelectrolyte-complex-coated substrates. The substrates precoated with polyelectrolyte complexes can readily be overcoated. Overcoating can be carried out by repeating a process mentioned above, or, by way of example, multiple coating can be carried out in a continuous process without any intervening wind-up and unwind of the foil. The location of the plasticizer-barrier layer is thus in the interior of the system, and surface properties are then determined by the topcoat layer. The topcoat layer has good adhesion to the plasticizer-barrier layer.

The thickness of the backing foils is generally in the range from 5 to 100 μm, preferably from 5 to 40 μm.

### EXAMPLES

All percentages are based on weight unless otherwise stated. Data for content is based on content in aqueous solution or dispersion. Viscosity can be determined to DIN EN ISO 3219 using a rotary viscometer at a temperature of 23° C.

Starting materials:
Vinnapas® EP 17: aqueous polymer dispersion produced from vinyl acetate and ethylene (about 60% solids) from Wacker
Borchigel® L75N: nonionic thickener based on a hydrophobically modified polyether urethane copolymer (50% in water)
Lupraphen® VP 9186: polyesterdiol (polyester having terminal OH groups, derived from adipic acid and 1,4-butanediol)
Lupranol® 1000: polypropylene glycol with weight-average molecular weight of 2000.
Lumiten® I-SC: wetting aid (sulfosuccinic ester)

### Inventive Example 1

### Cationic Polyurethane Dispersion

A dispersion of a cationic polyurethane was produced in water. The polyurethane has been formed from 0.3 mol of Lupraphen® VP9186 with OH number 45.8, 0.283 mol of tolylene diisocyanate, 0.283 mol of hexamethylene diisocyanate, and 0.25 mol of N-methyldiethanolamine, and lactic acid for pH adjustment.

Solids content: 41.2%; K value 45.4; viscosity 22 mPa s; pH 4.6.

### Inventive Example 2

### Cationic Polyurethane Dispersion

A dispersion of a cationic polyurethane was produced in water. The polyurethane has been formed from 0.3 mol of Lupraphen® VP9186 with OH number 45.8, 0.263 mol of tolylene diisocyanate, 0.263 mol of isophorone diisocyanate, and 0.21 mol of N,N-bis(3-aminopropyl)methylamine, and hydrochloric acid and phosphoric acid for pH adjustment.

Solids content: 41.7%; K value 44.8; viscosity 29.7 mPa s; pH 5.6.

### Inventive Example 3

### Anionic Polyurethane Dispersion

A dispersion of an anionic polyurethane was produced in water. The polyurethane has been formed from 0.4 mol of Lupranol® 1000 with OH number 56.0, 1.0 mol of tolylene diisocyanate, and 0.6 mol of dimethylolpropionic acid. Neutralization was achieved by using aqueous ammonia solution, the amount being sufficient to neutralize 90% of the acid groups of the dimethylolpropionic acid.

Solids content: 33.8%; K value 37.8; viscosity 1330 mPa s; pH 7.1.

### Inventive Example 4

### Anionic Polyurethane Dispersion

As inventive example 3, neutralization using ammonia to neutralize 60% of the acid groups

Solids content 39.8%; viscosity 119 mPa s; pH 6.7

### Inventive Example 5

### Anionic Polyurethane Dispersion

As inventive example 3, neutralization using KOH to neutralize 30% of the acid groups

Solids content: 44.3%; viscosity 18.5 mPa s; pH 6.6

### Inventive Example 6

### Anionic Polyurethane Dispersion

As inventive example 5, neutralization using KOH to neutralize 60% of the acid groups

Solids content: 37.6%; viscosity 178 mPa s; pH 6.7

### Inventive Example 7

### Anionic Polyurethane Dispersion

As inventive example 5, neutralization using KOH to neutralize 90% of the acid groups

Solids content: 31.9%; viscosity 861 mPa s; pH 7.1

### Inventive Example 8

### Anionic Polyurethane Dispersion

As inventive example 3, neutralization using ammonia to neutralize 30% of the acid groups

Solids content: 41.6%; viscosity 8.9 mPa s; pH 6.4

### Inventive Example 9

### Cationic Polyurethane Dispersion

A dispersion of a cationic polyurethane was produced in water. The polyurethane has been formed from 0.3 mol of Lupraphen® VP9186 with OH number 44.8, 0.325 mol of tolylene diisocyanate, 0.325 mol of hexamethylene diisocyanate, and 0.35 mol of N,N-bis(3-aminopropyl)methylamine, and lactic acid for pH adjustment.

Solids content: 34.9%; viscosity 809 mPa s; pH 6.7.

### Adhesive Composition 1

An adhesive composition was produced from 100 parts by weight of an adhesive dispersion, 50 parts by weight of Vinnapas® EP 17, 0.1 part by weight of Lumiten® I-SC, and 1 part by weight of Borchigel® L75N. The adhesive dispersion is a dispersion of a polyurethane in water. The polyurethane is composed of polyesterdiol (polyester having terminal OH groups, derived from adipic acid and 1,4-butanediol), isophorone diisocyanate (IPDI), hexamethylene diisocyanate (HDI), dimethylolpropionic acid (DMPA), aminoethylaminoethanesulfonic acid, and aminoethylaminoethanol.

### Plasticizer-Migration Testing:

For plasticizer-migration testing, foils made of flexible PVC (from Benecke Kaliko) with from 40 to 50% content of plasticizers (diisooctyl phthalate and diisobutyl phthalate) were coated with adhesive composition 1 (amount, layer thickness?). The layer thickness was 50 μm (solids). Other foils were produced by first applying a layer made of anionic polymer or made of cationic polymer (each layer 16 μm (solids)) or a double layer of the invention made of anionic and cationic polymer (each layer 16 μm (solids)) to the foil, and then drying to some extent before applying adhesive composition 1. The adhesive-coated PVC foils were stored for 24 hours at room temperature and, respectively, 10 days at 40° C. Once the storage time had expired, all of the foils were laminated in a press at 65° C. and a pressure of 1.4 N/mm² onto an ABS molding. The finished molding is subjected to a peel test after cooling. For this, foil strips of width 5 cm are peeled from the molding at an angle of 90° at an ambient temperature of 100° C., and the force for peeling the foil strips from the molding is determined. If there is a marked reduction in the peel forces for peeling of a foil stored at 40° C. for 10 days in comparison with a foil stored at room temperature for 24 hours, plasticizers have migrated into the adhesive layer and caused reduced adhesion.

Table 1 collates the results.

TABLE 1
Peel resistance in N/25 mm

| | Cationic | Anionic | after 24 h of | after 10 days of |
|---|---|---|---|---|
| Example | barrier | barrier | storage at RT | storage at 40° C. |
| 1 | — | — | 14 | 6.5 |
| 2 | Inv. ex. 1 | — | 14.9 | 11.1 |
| 3 | Inv. ex. 2 | — | 16.7 | 12.6 |
| 4 | — | Inv. ex. 3 | 19.3 | 13.8 |
| 5 | Inv. ex. 2 | Inv. ex. 3 | 11.5 | 16.5 |
| 6 | Inv. ex. 1 | Inv. ex. 3 | 11.4 | 19.6 |

A desirable minimum peel resistance value is at least 15 N/25 mm after storage at elevated temperature, and this is achieved only by inventive examples 5 and 6. Non-inventive examples 1 to 4 reveal a marked loss of adhesion, with adhesive fracture, after storage at elevated temperature. The relatively low initial adhesion of inventive examples 5 and 6 is believed to be attributable to cohesive fracture within the double polyelectrolyte layer, but the double layer of polyelectrolyte complex is believed to harden with time, then giving adhesions which cannot be achieved by the non-inventive examples.

Further examples of possible embodiments are provided by flexible PVC foils coated with a combination of cationic and anionic polyurethanes according to table 2.

TABLE 2
Polyelectrolyte-complex plasticizer barriers

| Example | Cationic barrier | Anionic barrier |
|---|---|---|
| IE1 | Inv. ex. 1 | Inv. ex. 4 |
| IE2 | Inv. ex. 1 | Inv. ex. 5 |
| IE3 | Inv. ex. 1 | Inv. ex. 6 |
| IE4 | Inv. ex. 1 | Inv. ex. 7 |
| IE5 | Inv. ex. 1 | Inv. ex. 8 |
| IE6 | Inv. ex. 2 | Inv. ex. 4 |
| IE7 | Inv. ex. 2 | Inv. ex. 5 |
| IE8 | Inv. ex. 2 | Inv. ex. 6 |
| IE9 | Inv. ex. 2 | Inv. ex. 7 |
| IE10 | Inv. ex. 2 | Inv. ex. 8 |
| IE11 | Inv. ex. 9 | Inv. ex. 3 |
| IE12 | Inv. ex. 9 | Inv. ex. 4 |
| IE13 | Inv. ex. 9 | Inv. ex. 5 |
| IE14 | Inv. ex. 9 | Inv. ex. 6 |
| IE15 | Inv. ex. 9 | Inv. ex. 7 |
| IE16 | Inv. ex. 9 | Inv. ex. 8 |

### Examples 17-19

### Aqueous Polyelectrolyte Complex Dispersions Produced by Water-In-Water Emulsion Polymerization

The initial charge used comprises an amount of water sufficient to produce a 20% strength by weight dispersion, and this is heated to reaction temperature of 65° C., and 0.1 mol % (based on the total amount of the monomers to be polymerized) of 2,2′-azobis(2-amidinopropane) dihydrochloride initiator is added. The amounts stated in the table below of acrylic acid (AA), ammonium hydroxide solution, 2-acrylamido-2-methylpropanesulfonic acid (AMPS) and, if appropriate, crosslinking agent are then added continuously. In parallel, the amounts stated in the table below of the cationic polymer Luviquat® FC 550 (vinylpyrrolidone/vinylimidazolium methochloride copolymer) are added. Crosslinking agents used comprise ethylene glycol diacrylate (inventive example IE18) and trimethylolpropane triacrylate (inventive example IE19).

The solids content of the dispersions was 17% by weight. The dispersions of the polyelectrolyte complexes remained stable for more than 2 months.

TABLE 3
Examples 17-19, quantitative data in mol

| | | | | Crosslinking | |
|---|---|---|---|---|---|
| | AA | AMPS | NH₄OH | agent | QVI¹⁾ |
| IE17 | 0.99 | 0.01 | 0.025 | 0 | 0.052 |
| IE18 | 0.99 | 0.01 | 0.025 | 0.0022 | 0.052 |
| IE19 | 0.99 | 0.01 | 0.025 | 0.0015 | 0.052 |

¹⁾Amount of quaternized vinylimidazole (constituent of cationic polymer)

### Screening Test for Plasticizer-Barrier Properties

A screening test on paper was carried out with the aqueous polyelectrolyte complex dispersions IE17 to IE19, produced by water-in-water emulsion polymerization, in order to evaluate their suitability as plasticizer barrier, and to visualize the extent of plasticizer migration. For this, commercially available printer paper (IMPEGA, weight per unit area: 80 g) was coated on one side with the polyelectrolyte complex dispersion to be tested, and dried at room temperature for 1 day. The layer thickness after drying was 14 μm. The films are flexible, rubbery and elastic, stable, non-brittle, and non-tacky. The coated specimens are used in a penetration test. Pure di-n-butyl phthalate (Palatinol® C) plasticizer is applied to the coated side of the paper (frontal side). This plasticizer was selected because preliminary tests had shown it to be more aggressive in terms of penetration than other commercially available plasticizers. Migration of plasticizer is apparent by virtue of visible discoloration of the uncoated reverse side of the paper, in the form of dark spots. The percentage proportion of discolored areas on the uncoated reverse side of the paper is determined after the periods stated in the table below. The stated values correspond to the approximate percentage of discolored surface.

For comparative example CE7, a coating was produced using a ZnO-crosslinked polyacrylic acid (Besela®, 1 mol of ZnO for every 2 mol of acrylic acid), the amount of coating being 10 g (solids)/m².

TABLE 4
Screening test for plasticizer penetration

| Example | 5 min | 1 h | 2 h | 18 h | 2 d |
|---|---|---|---|---|---|
| IE17 | 0% | 0% | 0% | 0% | 3% |
| IE18 | 0% | 0% | 0% | 0% | 0% |
| IE19 | 1% | 1% | 1% | 3% | 3% |
| CE7 | 90% | 100% | 100% | 100% | 100% |

The examples show that plasticizer-barrier properties are excellent, since uncoated papers or papers coated with films having inadequate plasticizer-barrier properties exhibit 100% penetration after a period of just 1 hour or even less, but for coatings of the invention the extent of penetration is markedly below 5% even after 2 days.

1. The use of polyelectrolyte complexes as plasticizer barrier.

2. The use according to the preceding claim, wherein the polyelectrolyte complexes have been formed from at least one anionic polymer and from at least one cationic polymer.

3. The use according to any of the preceding claims, wherein a constituent of the polyelectrolyte complex is an anionic polymer selected from anionic polyurethanes and from polymers capable of production from monomers selected from the group consisting of monoethylenically unsaturated C₃-C₁₀ carboxylic acids, vinylsulfonic acid, styrenesulfonic acid, acrylamidomethylpropanesulfonic acid, vinylphosphonic acid, and salts of these acids.

4. The use according to any of the preceding claims, wherein a constituent of the polyelectrolyte complex is a cationic polymer selected from the group consisting of cationic polyurethanes, polymers comprising vinylimidazolium units, polydiallyldimethylammonium halides, polymers comprising vinylamine units, polymers comprising ethyleneimine units, polymers comprising dialkylaminoalkyl acrylate units, polymers comprising dialkylaminoalkyl methacrylate units, polymers comprising dialkylaminoalkylacrylamide units, and polymers comprising dialkylaminoalkylmethacrylamide units.

5. The use according to any of the preceding claims, wherein the polyelectrolyte complex is formed from an anionic polyurethane and from a cationic polyurethane, or from a polymer polymerized by a free-radical route using acrylic acid or using methacrylic acid, and from a polymer having amino groups or having quaternary ammonium groups.

6. The use according to any of the preceding claims, wherein the plasticizer has been selected from phthalic esters, trimellitic esters with predominantly linear C₆-C₁₁ alcohols, acyclic, aliphatic dicarboxylic esters, alicyclic dicarboxylic esters, phosphoric esters, citric esters, lactic esters, epoxy plasticizers, benzenesulfonamides, methylbenzenesulfonamides, and mixtures of these.

7. The use according to any of the preceding claims, wherein a substrate made of flexible PVC comprising plasticizer has been provided with a barrier layer comprising at least one polyelectrolyte complex.

8. A plasticized substrate, the surface of which has been at least to some extent coated with at least one layer which comprises at least one polyelectrolyte complex.

9. The substrate according to the preceding claim, which is a coated, plasticized PVC foil.

10. The substrate according to either of the preceding claims, wherein the layer comprising the at least one polyelectrolyte complex has been coated directly or indirectly with an adhesive layer.

11. The substrate according to the preceding claim, wherein the adhesive has been selected from heat-sealable adhesives, cold-sealable adhesives, pressure-sensitive adhesives, hot-melt adhesives, radiation-crosslinkable adhesives, and thermally crosslinkable adhesives.

12. The substrate according to the preceding claim, which takes the form of a heat-sealable flexible-PVC foil or self-adhesive flexible-PVC tape.

13. A process for producing plasticized products with plasticizer barrier, where
(i) a substrate made of material comprising plasticizer is provided, and
(ii) the substrate is entirely or to some extent provided with one or more layers which comprise at least one polyelectrolyte complex.

14. The process according to the preceding claim, wherein either the method of coating with the polyelectrolyte complex uses a composition comprising at least one previously produced polyelectrolyte complex or the method of coating with the polyelectrolyte complex delays formation of the polyelectrolyte complex until the material is on the substrate.

15. The process according to the preceding claim, wherein the composition comprising the previously produced polyelectrolyte complex is an aqueous dispersion which has from 1 to 40% by weight content of polyelectrolyte complex and which is capable of production by water-in-water emulsion polymerization.

16. The process according to claim 14, wherein the substrate is provided with a first coating and with a second coating that is in direct contact with the first coating, where one of the coatings comprises at least one anionic polymer and the other coating comprises at least one cationic polymer, and formation of the polyelectrolyte complex made of anionic polymer and of cationic polymer is delayed until the material is on the substrate.

17. The process according to the preceding claim, wherein two coating compositions are applied simultaneously or in direct succession in one operation, where one of the coating compositions comprises the anionic polymer and the other coating composition comprises the cationic polymer.
